(19) United States
(12) Patent Application Publication
(10) Pub. No.: US 2007/0223907 A1
(43) Pub. Date: Sep. 27, 2007

(54) Photo-flash driving circuit

(76) Inventors: Kwang-Hwa Liu, Sunnyvale, CA (US); Cheng-Nan Wu, Hsinhua (TW)

Correspondence Address: RABIN & Berdo, PC, 1101 14TH STREET, NW, SUITE 500, WASHINGTON, DC, 20005, US

(21) Appl. No.: 11/387,689

(22) Filed: Mar. 24, 2006

(51) Int. Cl. G03B 7/26

(52) U.S. Cl. 396/206

(57) ABSTRACT

A driving circuit includes an input node, a power storage unit, a transformer, a charger IC, a rectifier diode and a high-voltage capacitor. The input node receives an DC input voltage. The transformer has a primary coil, whose first end connected to the input node, and a secondary coil. The power storage unit is connected to the second end of the primary coil for providing a supply voltage. The charger IC has a power pin for receiving the supply voltage, and a switch pin connected to the second end of the primary coil for providing a pulse series such that the transformer generates an AC voltage from the first end of the secondary coil. The rectifier diode is connected to the first end of the secondary coil. The high-voltage capacitor is connected to the cathode of the rectifier diode and charged for providing a high voltage to the photo-flash.

### BACKGROUND OF THE INVENTION 1. Field of the Invention

The invention relates in general to the driving circuit, and more particularly to the photo-flash driving circuit. 2. Description of the Related Art

The photo-flash of the camera illuminates the subject to be photographed. The Xenon light bulb used in the photo-flash operates at a high voltage, about 300V to 330V. But the camera operates from, for example, two Alkaline batteries connected in series, which provides 3.3V voltage while the battery cells are new. Therefore, a converting circuit is needed to boost the battery voltage to about 300V for driving the photo-flash.

FIG. 1 is a circuit diagram showing a conventional photo-flash driving circuit. The photo-flash driving circuit 100 converts the input voltage Vin at the input node into a high voltage Vo for driving the photo-flash 150. The photo-flash driving circuit 100 is a flyback converter that includes an input capacitor C1, a charger IC 110, a transformer 160, a rectifier diode D2, a diode D3 and a high-voltage capacitor C2. The charger IC 110 comprises a power pin P1 for receiving a supply voltage Vcc, and a switch pin P2 connected to the primary coil of the transformer 160 for outputting a pulse series such that an AC voltage is generated at the secondary coil of the transformer 160. Capacitor C2 is charged by the AC voltage via diode D2. When the capacitor C2 is charged to about 300V, a LED (not shown in the figure) of the photo-flash driving circuit 100 turns on to indicate that the photo-flash 150 is ready to strobe.

IC 110 includes a transistor Q1 and a control circuit 112 for turning transistor Q1 on and off alternatively. The control circuit 112 includes a start-up circuit 121, a Vo/Vin comparator 123, an OR gate 125, an AND gate 127, a peak current detector 129, a SR flip/flop 131, and a Vo detector 133. FIG. 2 shows signal waveforms of the photo-flash driving circuit 100. Transistor Q1 always turns on at zero current condition. First, start-up circuit 121 receives a CHARG signal and issues a high signal to set SR flip/flop 131 such that transistor Q1 turns on at time t1, and input current I1 gradually increases by the rate of Vin/Lp, where Lp is the primary-side self inductance of transformer 160. After input current I1 reaches a preset peak limit Ipk at time t2, the peak current detector 129 resets SR flip/flop 131 to turn off transistor Q1.

After time t2, transistor Q1 turns off and its collector-emitter voltage Vce increases from low level (Vce saturation) to Vin+Vo/n, where n is the turns-ratio of transformer 160. As Vce exceeds the level of Vin+Vo/n, input current I1 at the primary coil commutates to the secondary coil as the output current, I2, and rectifier diode D2 turns on. During and after a very short transition period, output current I2 flows into capacitor C2 and gradually decreases from Ipk/n to zero by a rate of −Vo/Ls, where Ls is the secondary-side self-inductance of transformer 160.

Once output current I2 drops to zero, rectifier diode D2 turns off. Then Vce begins to drop via Lp. When Vce drops below the level of Vin, at time t3, comparator 123 issues a high signal to set SR flip/flop 131, such that transistor Q1 turns on again.

Transistor Q1 switches at a frequency ranging from 50 kHz to 300 kHz. As output voltage Vo increases, the conduction time of output current I2 gets shorter, and that the switching frequency of transistor Q1 increases. Capacitor C2 is charged to its rated level after many switching cycles. When Vo detector 133 detects C2 is fully charged, a photo-flash ready signal is issued.

Diode D3, connected in parallel with transistor Q1, provides a reverse current path to keep Vce from swinging too far below zero.

However, in a typical photoflash circuit, the input voltage, Vin, is provided by two Alkaline batteries. Vin is 3.3V while the batteries are new, and Vin may dwindle to 1.8V while the energy of the batteries is exhausted. In general, the charger IC will not work properly if the input voltage is too low. Take the LT3468 charger IC of Linear Technology Coporation for example, it specifies an operating input voltage range from 2.5V to 8V. It will not work properly if the input voltage is below 2.5V because there would not be a sufficient voltage to drive transistor Q1 into deep saturation (Vce <0.2V).

Alternatively, transistor Q1 can be replaced by a MOSFET. Again, Vin of 2.5V would not turn on the MOSFET completely. The Rds(on) of the MOSFET at Vgs=2.5V is several times larger than the Rds(on) at Vgs=5V. If the Vgs is 1.8V, the Rds(on) would be much worse.

Consequently, the efficiency would be very poor if the input voltage is low, and in some cases the efficiency may drop to well below 50%. In other word, up to half of the input power is dissipated as loss and won't reach the secondary side to charge the output capacitor.

### SUMMARY OF THE INVENTION

It is therefore an object of the present invention to provide an improved photo-flash driving circuit that can operate properly and efficiently over a wide range of input voltage.

The invention achieves the above-identified object by providing a photo-flash driving circuit, which includes an input node, a transformer, a charger IC, a rectifier diode and a high-voltage capacitor. The input node receives a DC input voltage. The transformer has a primary coil, whose first end is connected to the input node, and a secondary coil. A power storage unit is connected to the second end of the primary coil for providing a supply voltage to the charger IC. The charger IC has a power pin for receiving the supply voltage, and a switch pin connected to the second end of the primary coil for providing a pulse series such that the transformer outputs an AC voltage from the first end of the secondary coil. The anode of the rectifier diode is connected to the first end of the secondary coil. The capacitor is connected to the cathode of the rectifier diode and charged for providing an output voltage to the photo-flash.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 (Prior Art) is a circuit diagram showing a conventional photo-flash driving circuit.

FIG. 2 shows signal waveforms of the photo-flash driving circuit as described in FIG. 1.

FIG. 3 is a circuit diagram of a driving circuit for a photo-flash according to the preferred embodiment of the invention.

FIG. 4 shows the signal waveforms of the output voltage Vo and the voltage Vcc versus time of the circuit as described in FIG. 3.

### DETAILED DESCRIPTION OF THE INVENTION

FIG. 3 is a circuit diagram of a driving circuit for a photo-flash according to the preferred embodiment of the invention. A photo-flash driving circuit 300 converts an input voltage Vin into a high voltage Vo for driving a photo-flash 350. Photo-flash driving circuit 300 includes a power storage unit 310, a capacitor C1, a charger IC 110, a transformer 360, a rectifier diode D2 and a high-voltage capacitor C2. Charger IC 310 includes a power pin P1 for receiving a supply voltage Vcc from a recovery capacitor C3 and a switch pin P2 connected to the primary coil of a transformer 360. Switch pin P2 provides a pulse series such that an AC voltage is generated at the secondary coil of the transformer 360. Capacitor C2 is charged by the AC voltage via a rectifier diode D2. When capacitor C2 is charged to about 300V, a LED (not shown in the figure) of photo-flash driving circuit 300 turns on to indicate photo-flash 350 is ready to strobe.

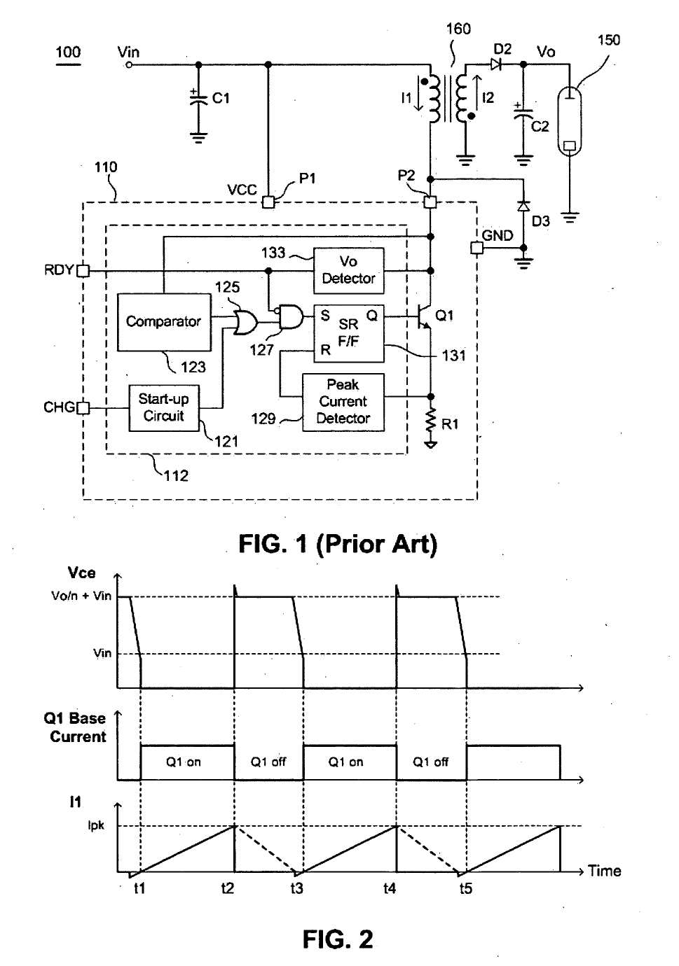

Charger IC 310 includes a transistor Q1 and a control circuit 312 for turning transistor Q1 on and off alternatively. The operation of charger IC 310 is similar to charger IC 110 as described and shown in FIG. 1.

Power storage unit 310 includes a recovery diode D1 and a recovery capacitor C3 to store the leakage energy from transformer 330 during its switching operation for providing the supply voltage Vcc to charger IC 310.

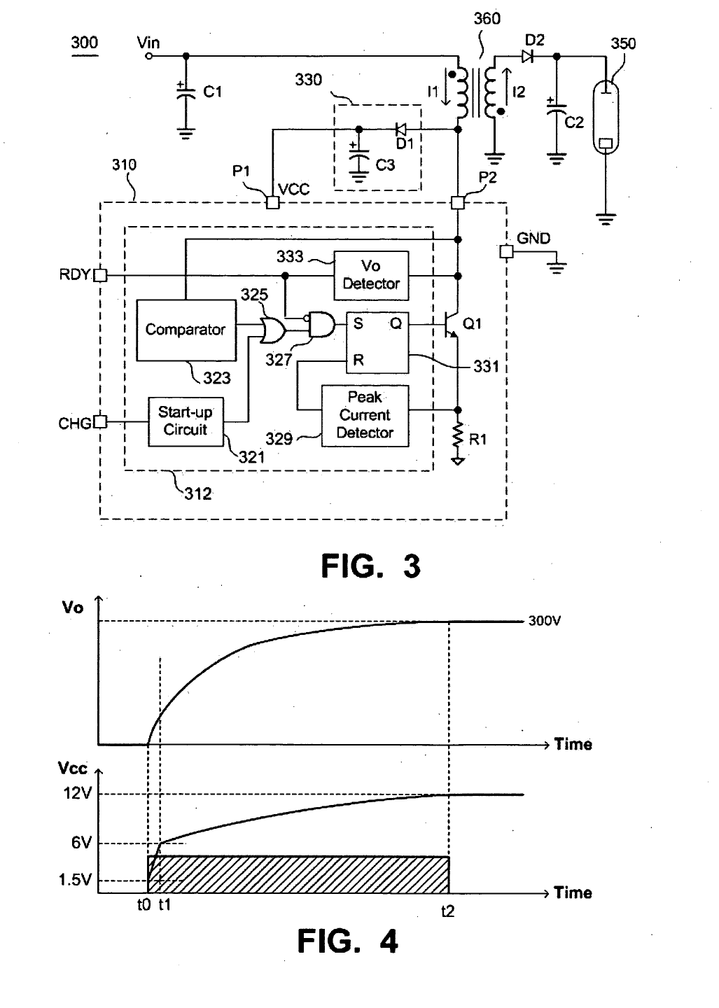

FIG. 4 shows the signal waveforms of the photo-flash driving circuit 300. As charger IC 310 starts to operate, output voltage Vo increases from 0V. Vo at the secondary side is reflected to the primary side (Vo/n) and coupled to the input voltage Vin for supplying the supply voltage Vcc to charger IC 310. Initially, voltage source Vcc is Vin-Vd1, where Vd1 is the forward voltage of recovery diode D1. If Vin is 2V and Vd1 is 0.5V, the initial Vcc voltage is only 1.5V. But once the start-up phase begins, the energy stored in the primary-side leakage inductance of the transformer 360 boosts Vcc quickly from 1.5V to 6V in a very short period.

Transistor Q1 can be either a bipolar transistor or a power MOSFET The energy stored in the primary-side leakage inductance is roughly 0.5*Lk*Ipk². If Lk=0.2 uH, Ipk=1.0A, each switch-on cycle of the MOSFET creates a leakage energy of 0.1 ujoule. At a switching frequency of 150 kHz, the leakage power is 15 mW. Assuming the charger IC consumes 2 mA current at an average supply voltage of 4V, it consumes 8 mW power. Therefore, to charge a 1 uF recovery capacitor C1 from 1.5V to 6V, it takes about 26 ms and 18 uJoule. If the total-charging time of the photo-flash 350 is 5 seconds, only the initial 26 ms (0.52%) is required to boost the voltage source Vcc from 1.5V to 6V. In the initial 26 ms period, the MOSFET is driven with a Vgs of less than 6V, and the Rds(on) of the MOSFET may not be the lowest. Then, Vgs increases from 6V to about 12V, as capacitor C2 is charged to about 300V. Thus, Rds(on) is the lowest for the majority of the overall charging period.

The photo-flash driving circuit according to the preferred embodiment has the following advantages:

1. The driving circuit can operate over a wide input voltage range, as low as 1.8V;

2. No extra wire is needed to connect the power pin of the charger IC to an external supply voltage, such as a 5V source.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A driving circuit for a photo-flash, comprising:
an input node for receiving an DC input voltage;
a transformer having a primary coil, whose first end connected to the input node, and a-secondary coil;
a power storage unit connected to the second end of the primary coil for providing a voltage source;
a charger IC having a power pin for receiving the said voltage source, and a switch pin connected to the second end of the primary coil for providing a pulse series such that the transformer generates an AC voltage from the first end of the secondary coil;
a rectifier diode whose anode connected to the first end of the secondary coil;
a high-voltage capacitor connected to the cathode of the rectifier diode and charged for providing a high voltage to the photo-flash.

2. The driving circuit according to claim 1, wherein the power storage unit comprises:
a recovery diode, whose anode connected to the second end of the primary coil; and
a recovery capacitor connected to the cathode of the recovery diode and charged for providing the said voltage source;

3. The driving circuit according to claim 1, wherein the charger IC comprises:
a power switch having a control end, a first power end connected to the switch pin, and a second power end connected to the ground; and
a control circuit connected to the control end for turning the power switch on and off alternatively.

4. The driving circuit according to claim 3, wherein the power switch is a MOSFET.

5. The driving circuit according to claim 3, wherein the power switch is a bipolar junction transistor.
